(19) United States
(12) Patent Application Publication
(10) Pub. No.: US 2008/0160233 A1
(43) Pub. Date: Jul. 3, 2008

(54) Protective-coated thermal labels

(76) Inventors: David Paul Luther, Duncanville, TX (US); Cathy Stox Russos, Raleigh, NC (US)

Correspondence Address: MCDERMOTT, WILL & EMERY LLP, 227 WEST MONROE STREET, SUITE 4400, CHICAGO, IL, 60606-5096, US

(21) Appl. No.: 11/645,873

(22) Filed: Dec. 27, 2006

(51) Int. Cl. B41M 5/40; B41M 7/00

(52) U.S. Cl. 428/32.39; 428/211.1; 427/558; 427/553

(57) ABSTRACT

The present invention discloses a radiation-cured protective coated label of the type used in direct thermal printing. The radiation-cured protective coated label comprises a face stock selected from thermal papers and a radiation-cured top coat which is applied to the top-side surface of the thermal paper using letter press printing technology. The radiation-cured protective top coat protects the imprinted text which is applied to the label from fading, smearing or darkening. The radiation-cured protective coated label can be affixed to a variety of containers.

### FIELD OF THE INVENTION

The present invention discloses a radiation-cured protective coated label of the type used in direct thermal printing. The labels of the present invention can be affixed to a variety of containers including containers for pharmaceuticals.

### BACKGROUND OF THE INVENTION

Thermal printing comprises the following components: a thermal head which generates heat for printing on thermal paper by contact; a platen—a rubber roller that feeds paper through the printer; a spring—applies pressure to the thermal head, causing it to contact the thermo-sensitive paper; and controller boards—for controlling or automating the mechanism of the printing process.

In order to print, one inserts thermo-sensitive paper between the thermal head and the platen. The printer sends an electrical current to the heating resistor of the thermal head, which in turn generates heat in a prescribed pattern on the paper. The heat activates the thermo-sensitive coloring layer of the thermo-sensitive paper, which manifests a pattern of color change in response. Such a printing mechanism is know as a thermal system or direct thermal system.

The paper, which is used in thermal printing, is also called thermal paper or thermo-chromic paper. It is impregnated with a mixture of a dye and a compatible matrix material. A combination of a fluoran leuco dye and an octadecylphosphonic acid (as a compatible matrix material) is an example. When the matrix is heated above its melting point, the dye reacts with the acid, shifts to its colored form, and the changed form is then conserved in metastable state if the matrix re-solidifies quickly enough. (Thermochromism is the ability of a substance to change color due to a change in temperature.)

Thermal papers are generally used in many applications which can be exemplified by, but not limited to, point of sales receipts; admission, transportation, or lottery tickets; mailing labels; medical records; facsimile machine output; delivery and food retailing labels; labels for containers housing ethical pharmaceuticals and labels which are affixed to I.V. bags, syringes and vials.

A thermal paper consists of a base paper and a coating comprising a layer of heat sensitive chemicals known as the thermal layer. The thermal layer further comprises a mixture of the following components: color former, color developer, and sensitizer. When heat is applied from the thermal print head, the sensitizer melts, bringing together the color former and color developer to form an image such as an imprinted text. In addition to the thermal layer, other coatings, or layers, can be present, for example a top coat, a base coat, and a back coat.

A major preservation problem with thermal papers is that the chemical image-producing layer (thermal layer) remains active after the image is produced. Thermal papers are sensitive to light, which can increase the rate of deterioration, whether darkening or fading of the image such as an imprinted text. Also, exposure to heat or moisture can cause the printed image to fade and the surrounding area to darken. The thermal layer can also be darkened by friction if rubbed against other objects, as well as exposure to solvents such as alcohols. In response to these preservation problems which are associated with the use of thermal papers, a top coat, or top layer, is applied to the thermal layer prior to imaging or imprinting of any text. It is the function or purpose of the top coat or top layer to form a layer of protection for the thermal layer, thus eliminating or preventing any of the previously mentioned preservation problems.

Thermal papers are utilized in many areas, but one of the most frequently used areas is the use of thermal papers as labels for containers housing ethical pharmaceuticals (direct thermal labels).

Direct thermal labels have been used successfully as labels for containers housing ethical pharmaceuticals as well as other health care applications for many years. While the thermal papers used for these types of applications had been satisfactory, preservation problems such as described earlier have appeared recently. It is theorized that the reason for this type of decline in the direct thermal labels can be traced to different, thermal paper of somewhat lower quality including a somewhat inferior top coat layer.

Manufacturers efforts to reduce the cost of the thermal paper and to meet the demands of customers who seek faster burn-in rates at lower heat settings led to alteration of the chemical coating (top coat) which is applied to the base paper (thermal paper).

While this change in the chemical coating, applied to the basic face stock (thermal paper), has provided faster burn-in rates at lower heat settings it has also introduced preservation problems for the customers seeking long-term, legible text. Thus, the current chemical coating which is the top coat of the thermal paper which affords faster burn-in rates at lower heat settings also has introduced other preservation problems for the direct thermal labeling users not previously seen.

Accordingly, there is need for a protective top coat which can be applied to the top surface layer of current thermal paper which will prevent or reduce the preservation problems currently associated with direct thermal labeling, especially in the area of direct thermal labels for containers housing ethical pharmaceuticals. The protective top coat of the present invention is applied on top of the chemical coating (top coat) of the thermal paper.

### SUMMARY OF THE INVENTION

It is an object of the present invention to provide a label of the type used in direct thermal printing which is capable of faster burn-in rates at lower heat settings and that can be imprinted with text which is resistant to fading, smearing, and darkening.

It is a further object of the present invention to provide a label of the type used in direct thermal printing comprising face stock and a radiation-cured protective top coat.

It is a still further object of the present invention to provide a radiation-cured protective top coat which can be applied to the top side surface of the face stock of the label.

The present invention provides a label comprising a radiation-cured protective top coat applied to the top side surface of face stock using letter press printing with flexographic printing being a preferred printing method. The label of the present invention provides for a radiation-cured protective top coat. The radiation-cured protective top-coat protects the imprinted text which is later applied to the label from fading, smearing, darkening and generally becoming illegible to the reader. The label of the present invention can be affixed to containers suitable for housing pharmaceuticals.

### DETAILED DESCRIPTION OF THE INVENTION

The label of the present invention comprises face stock and a radiation-cured protective top coat applied to the top-side surface of said face stock.

The face stock of the present invention includes paper, wherein paper can be defined as a fitted sheet of usually vegetable fibers laid down on a fine screen from a water suspension. The face stock of the present invention is also meant to include paper which is formed from combinations of synthetic and plant fibers. The face stock of the present invention is still further meant to include face stock which is formed from synthetic polymeric materials, such as polyolefins which can be exemplified by polyethylenes and polypropylenes. The face stock of the present invention can comprise a single layer or multiple layers. The face stock of the present invention can comprise components in addition to those described above. These additional components can be exemplified but not limited to colorants and adhesives wherein adhesives can further be exemplified but not limited to solvent-base adhesives. The face stock of the present invention can also be affixed to one or more substrates. The substrates can be exemplified but not limited to paper wherein paper is defined as above, polymeric films and foils. If the face stock of the present invention is affixed to more than one substrate, the combination of substrates can include the same substrate or different substrates.

The preferred face stock for practice in the present invention is a thermal paper wherein said thermal paper can comprise one or more layers. A preferred thermal paper comprises more than one layer. A thermal paper suitable for practice in the present invention comprises (a) a chemical top coat layer; (b) a thermal layer comprising a mixture of color pigments, color developers and sensitizers; (c) a base coat layer; (d) a paper layer; and (e) a back coat layer comprising an adhesive thereby forming a label that can be adhered to items, such as phamaceutical containers or the like. A thermal paper particularly suitable for the practice of this invention is Fasson®Direct-Therm 300 HD/AT20/40# SCK which is produced by Fasson Roll North America located in Painesville, Ohio. A thermal paper as described above may also comprise one or more additional layers. These additional layers may be added to the top side surface or bottom side surface of the thermal paper or may interrupt one or more of the layers previously described. An example of one such layer would be a layer placed between the paper layer and the back layer. This layer would prevent any absorption of the adhesive by the paper layer. It is to be understood that the radiation-cured protective top coat of the present invention is applied to the top side printable surface of the thermal paper.

The radiation-cured protective top coat can be formed from materials such as acrylate monomers and oligomers. Preferred materials for the radiation-cured protective top coat can be exemplified by but not limited to 52110 Solvent Resistant top coat produced by Northwest Coating Corporation of 7221 South 10th Street, Oak Creek, Wis. and Water Ink Technology RV M001220. The radiation-cured protective top coat may comprise a single material such as Northwest Coat 52110 or may comprise a comingation of materials such as a combination of Northwest Coat 52110 and Water Ink Technology RV M001220. While it is understood that the radiation-cured protective top coat comprises materials such as described above, it is also to be understood that the radiation-cured protective top coat may further comprise additional additives such as fillers, pigments, dyes, other polymers, and non-polymeric materials etc.

Since the radiation-cured protective top coat is cured using electromagnetic radiation, the composition of the radiation-cured protective top coat should be such that the polymeric material does not inhibit or prevent the curing process. Infra-red (IR), ultra-violet (UV) and visible light are all forms of the same phenomenon-electromagnetic radiation, which essentially transports radiant energy from one point in space to another. Infra-red, ultra-violet and visible light are all contained in the electromagnetic spectrum. Infra-red radiation is relatively lower than the specific energy intensity of visible radiation while ultra-violet radiation is more energetic than visible radiation. A preferred method for curing the protective top coat of the present invention is with the use of ultra-violet radiation.

The radiation-cured protective top coat can be a single layer or multiple layers. It is to be undertood that in a multiple layer exemplification of the radiation-cured protective top coat, the additional layers may independently comprise the same material or different materials. The materials can be exemplified by but not limited to fillers, pigments, dyes, polymeric materials and non-polymeric materials.

The radiation-cured polymeric layer is applied to the face stock using letter press printing methods with the flexographic printing method being preferred.

Flexography is a letter press process using rubber plates on the plate/cylinder. Flexography printing offers a medium quality which is useable for course surfaces as pasteboard, wrapping paper, plastic or metal film. A complete discussion of the flexography printing process can be found in:

Reference: “Foundation of Flexographic Technical Association,”

Fourth or Fifth Edition

Title: Flexography . . . Principals and Practices

Address: 900 Marconi Avenue, Library of Congress, #9171436

Ronkonkoma, N.Y. 11779-7212.

Once the protective top coat is applied to the face stock, it is cured using radiation. A preferred radiation curing process is exposure to UV light using a pressure mercury arc lamp.

The radiation-cured protective top coat which has been described above provides protection from fading, smearing and darkening of the imprinted text which is applied after curing to the label.

The radiation-cured label of the present invention can be affixed to a variety of plastic and non-plastic containers. The label of the present invention can be produced in a variety of shapes and sizes. The shape and size of the label will, of course, depend on the shape and size of the container to which it is affixed.

The invention will now be described with reference to the following non-limiting examples.

### EXAMPLE 1

### Preparation of the Protective Coated Label

The radiation cured protective top coat is applied to the face stock (Fasson thermal paper) with a flexographic ink distribution system utilizing a reverse angle doctor blade with an open metering roll. The radiation-cured protective top coat is distributed to the face stock via printing plate, for spot applications, or tent sleeve, for total coverage, then transferred into an ultra violet dryer for curing.

The use of a 300 line anilox roller and reverse angle doctor blade delivers the necessary coat weight for consistent results thereby maintaining resistance to preservation problems discussed earlier in this disclosure while still delivering a minimal amount of coating to deter insulating effects which might minimize thermal imaging on the face stock for the thermal print head.

When ink color is utilized for warning labels or logos, a water based ink is used which must be catalyzed to help resist softening of the ink and transferring to the thermal print head. Success is also found using a UV-sensitized ink.

### EXAMPLE 2

A label of the present invention was prepared according to the procedure described in Example 1. The label was then imprinted with text via a direct thermal printing process. The label with imprinted text was then tested as follows:
A rag saturated with isopropyl alcohol was passed across the imprinted text side of the label. The label was allowed to sit for three minutes before a determination was made regarding the quality of the label's imprinted text.

After the three minute period, a visual review of the label's imprinted text revealed no adverse effects such as smearing, fading or darkening of the imprinted text.

### EXAMPLE 3

A label of the present invention was prepared according to the procedure described in Example 1. The label was then imprinted with text via a direct thermal printing process. The label with imprinted text was then tested as follows:
A few drops of hand sanitizer was applied to the imprinted text side of the label.

The above-described label then was allowed to sit for three minutes before wiping the label clean of the hand sanitizer. After this process was completed, a determination regarding the quality of the label's imprinted text was made.

A visual review of the imprinted text revealed no adverse effects such as smearing, fading or darkening of the imprinted test.

While the foregoing has described what is considered to be the best mode and/or other examples, it is understood that various modifications may be made therein and that the subject matter disclosed herein may be implemented in various forms and examples, and that they may be applied in numerous other applications, combinations and environments, only some of which have been described herein. Those of ordinary skill in that art will recognize that the disclosed aspects may be altered or amended without departing from the true spirit and scope of the subject matter. Therefore, the subject matter is not limited to the specific details, exhibits and illustrated examples in this description. It is intended to protect any and all modifications and variations that fall within the true scope of the advantageous concepts disclosed herein.

What is claimed is:

1. A label wherein said label comprises:
a face stock wherein said face stock is selected from the group consisting of a thermal paper, paper formed from a combination of synthetic and plant fibers, paper formed from vegetable fibers, and films formed from polyolefins; and
a protective top coat layer applied to the top side printable surface of the face stock and wherein said protective top coat is cured by electromagnetic radiation.

2. The label according to claim 1 wherein said face stock is a thermal paper.

3. The label according to claim 2 wherein the thermal paper comprises a single layer.

4. The label according to claim 2 wherein the thermal paper comprises multiple layers.

5. The label according to claim 2 wherein said thermal paper comprises the following layers:
(a) chemical top coat layer;
(b) a thermal layer;
(c) a base coat layer;
(d) a paper layer; and
(e) a back coat layer.

6. The label according to claim 1 wherein said electromagnetic radiation is ultra-violet.

7. The label according to claim 1 wherein said protective top coat layer is applied to said face stock using letter press printing technology.

8. The label according to claim 1 wherein said label is used in direct thermal printing.

9. The label according to claim 1 wherein said protective top coat layer comprises acrylate monomers and oligomers.

10. The label according to claim 1 wherein said label can be affixed to a container.

11. The label according to claim 1 having imprinted text applied to the top side surface layer after application of the protective top coat.

12. The label according to claim 11 wherein the imprinted text is resistant to fading, smearing or darkening.

13. The label according to claim 10 wherein said container houses pharmaceuticals.

14. The label according to claim 1 wherein said label is a direct thermal label.

15. A direct thermal label for use on containers suitable for housing pharmaceuticals wherein said label comprises:
a thermal paper comprising a single layer or multiple layers;
a protective top coat layer wherein said protective top coat layer is applied to the top-side printable surface of the thermal paper; and wherein said protective top coat layer is cured by electromagnetic radiation.

16. The direct thermal label according to claim 15 wherein said thermal paper comprises multiple layers.

17. The direct thermal label according to claim 15 wherein said thermal paper comprises at least (a) a chemical top coat, (b) paper layer and (c) a back layer.

18. The direct thermal label of claim 15 wherein said label contains printed text.

19. The direct thermal label according to claim 15 wherein said protective top coat comprises acrylate monomers and oligomers.

20. A method for preventing or reducing the smearing, fading or darkening of imprinted text upon a thermal label wherein said thermal label comprises face stock and a protective top coat layer and wherein said method comprises:
applying said protective top coat layer to the top side printable surface of said face stock; and
curing said protective top coat layer by electromagnetic radiation prior to the imprinting of text.

21. The method of claim 20 wherein said electromagnetic radiation is ultra-violet.

22. The method of claim 20 wherein the face stock is a thermal paper.
